(19) United States
(12) Patent Application Publication
(10) Pub. No.: US 2022/0137220 A1
(43) Pub. Date: May 5, 2022

(54) METHOD OF INDIRECT TIME OF FLIGHT DEPTH MAP ACQUISITION AND CORRESPONDING SENSOR

(71) Applicant: STMicroelectronics (Grenoble 2) SAS, Grenoble (FR)

(72) Inventor: Cedric Tubert, Saint-Egreve (FR)

(21) Appl. No.: 17/481,960

(22) Filed: Sep. 22, 2021

(30) Foreign Application Priority Data
Oct. 30, 2020 (FR) 2011151

(51) Int. Cl. G01S 17/89; G01S 7/4865

(52) U.S. Cl. CPC G01S 17/89; G01S 7/4865

(57) ABSTRACT

In an embodiment a method for acquiring a depth map by indirect time of flight in a network of photosensitive pixels segmented into groups of pixels includes performing at least one capture during which the pixels of the network are controlled by a demodulation signal and introducing phase shifts into the demodulation signal at different values distributed in each group of pixels.

### CROSS-REFERENCE TO RELATED APPLICATIONS

This application claims the benefit of French Patent Application No. 2011151, filed on Oct. 30, 2020, which application is hereby incorporated herein by reference.

### TECHNICAL FIELD

The present disclosure relates to integrated circuits, in particular to the integrated sensors for acquiring a depth map by indirect time of flight (usually designated by the acronym “iToF”).

### BACKGROUND

Conventionally, time-of-flight measurement systems measure the duration between the instant of emission of an optical signal, that is to say a light signal, and the instant of reception of this signal after reflection on elements present in the detection field, that is to say the field of view of the system in the illuminate zone. The distance separating the elements of the detection field and the system is reconstructed on the basis of the duration measured, proportionally to the celerity of light.

The “iToF” indirect time of flight systems emit an optical signal modulated at a modulation frequency, and measure the phase difference of the modulation of the signal received with respect to the signal emitted. The measurement of the phase difference can be obtained from the quantity of charges photogenerated by pixels of a receiver during periods of integration controlled by a demodulation signal synchronous with the modulation of the optical signal.

Two samplings offset by 180° (that is to say two successive integrations controlled by the demodulation signal in phase and by the demodulation signal offset by 180°, respectively) suffice to reconstruct the phase shift.

That being said, techniques using more than two samplings, for example such as the technique called “4-bin sampling” using four samplings with differential components offset by 90° of the demodulation signal (that is to say differential components at 0° and 180° and differential components offset by 90° at 90° and 270°, are more commonly implemented since they have advantages in particular because of the known and mastered mechanisms of demodulation of signals offset by 90° (“in-phase (I)/quadrature (Q)” in the field of radio-frequency communications).

Increasing the modulation frequency improves the precision of the distance measured, but also increases the ambiguity of the measurement (that is to say the periodicity of the different distances resulting in the same phase difference), which reduces the range of the measurement. That being said, techniques of measurements on several modulation frequencies allow the problems related to the ambiguity to be limited.

It is desirable to propose systems for acquiring a depth map by indirect time of flight having a high resolution, for example approximately one megapixel, and at a high modulation frequency, for example greater than 100 MHz (megahertz) or even greater than 200 MHz.

However, increasing the modulation frequency and the resolution of the conventional systems produces very high direct currents, for example close to 2A (amperes) for a iMegapixel sensor modulated at 200 MHz, during the phase of integration and also peaks of capacitive currents close to 25A over approximately one hundred picoseconds.

These peaks of current generate on the one hand very high “EMI” electromagnetic interference, and cause on the other hand drops in the power supply voltage and increases in the ground voltage, which can in particular disturb the switching of logic elements and degrade the synchronization of the measurement of time of flight.

Consequently, there is a need to propose solutions overcoming the problems caused by the peaks of currents mentioned above, in systems for acquiring a depth map by indirect time of flight at high resolution and at a high modulation frequency.

### SUMMARY

According to embodiments, it is proposed to spatially allocate in a matrix of photosensitive pixels phase shifts on the demodulation signal, in order to spread out the electromagnetic interference. The spatial allocation of the phase shifts can be defined on a preestablished pattern of pixels, which can be one or more columns, one or more lines, or a rectangular subnetwork of pixels.

According to one embodiment, a method is proposed for acquiring a depth map by indirect time of flight in a network of photosensitive pixels segmented into groups of pixels, comprising at least one capture during which the pixels of the network are controlled by a demodulation signal, the method comprising an introduction of phase shifts into the demodulation signal at different values and distributed in each group of pixels.

For example, if the acquisition comprises four captures during which the demodulation signal used is provided offset by 180° or offset by 90°, the introduction of the phase shifts at different values distributed in each group of pixels is carried out on the demodulation signals having the respective phase shifts by 180° or by 90° at each capture.

Thus, because of the distribution of the phase shifts on the demodulation signal in the groups of pixels of the network, the pixels of the network are not all controlled at the same instants by a single demodulation signal during a capture, but the instants at which the pixels are controlled are distributed over time.

Consequently, the peaks of currents consumed in the network have lower intensities and are distributed over time, and the amplitude of the electromagnetic interference that results therefrom is reduced proportionally to the number of different phase shifts. Moreover, the frequency of the electromagnetic interference is shifted proportionally to the number of different phase shifts.

According to one embodiment, the values of the phase shifts are discretely distributed over a period of the demodulation signal.

For example, “discretely distributed” means a distribution in a quantity voluntarily limited to a number much smaller than the maximum quantity of different phase shifts that can be introduced in theory.

According to one embodiment, the network is arranged into columns and into rows of pixels, and the number of discrete values of phase shifts is between substantially one hundredth and substantially one tenth of the number of columns or of rows. “Substantially” means for example “rounded up or down to the closest integer.”

Indeed, providing a discrete number of phase shifts has implementation advantages, in particular with simpler and less costly means, but also in a manner that is easier to control from the point of view of calibration of the phase shifts introduced, that is to say the precision of the generation of the phase shifts.

Moreover, the values of the phase shifts can be uniformly distributed over a period of the demodulation signal, or not. Nevertheless, a uniform distribution of the phase shifts over a period of the demodulation signal allows an optimal minimization of the electromagnetic interference.

And, distributing the values of the phase shifts relative to a period of the demodulation signal allows to control the shifted frequency of the electromagnetic interference that results therefrom, and to carry out a spectral spreading out that is reproducible regardless of the modulation frequency, contrary for example to arbitrary phase shifts which would lead to an uncontrolled spectral spreading out. This is even more advantageous in the context of an acquisition at several modulation frequencies.

According to one embodiment, the number of different values of the phase shifts is chosen so that the product of the frequency of the demodulation signal and said number is located outside of a bandwidth of interest.

Indeed, the electromagnetic interference can be particularly problematic for certain frequencies, for example in a bandwidth of interest containing the frequencies at which systems neighboring the system implementing the acquisition of the depth map operate. Also, certain materials of the system implementing the acquisition of the depth map can, by nature, attenuate the frequencies beyond a given bandwidth, forming the bandwidth of interest in the context of this embodiment.

According to one embodiment, the network is arranged into columns and into rows of pixels and the groups of pixels are segmented according to a periodic pattern on the columns and/or on the rows.

Choosing a periodic pattern in the plane of the pixel network allows in space the consumption of current to be distributed, limiting the appearance of constructive phenomena in the generation of the electromagnetic interference, and making uniform the performance of the system.

According to one embodiment, the groups of pixels are segmented according to a periodic pattern of one or more column(s) so that each group includes several spatially non-consecutive columns or several spatially non-consecutive blocks of spatially consecutive columns.

This embodiment is advantageous in terms of distribution of the signals in the case in which the architecture of the network of pixels provides a distribution of the demodulation signal by columns of pixels.

According to one embodiment, the method further comprises a calculation of a phase difference of time of flight, for each pixel, between the demodulation signal and a light signal received during said at least one capture, and the calculation of the phase difference of time of flight comprises a compensation for the phase shift introduced on the demodulation signal for each group of pixels.

According to one embodiment, said compensation comprises, for each group of pixels, a modulo 360° addition of the value of the phase shift introduced on the corresponding demodulation signal to the phase difference of time of flight calculated.

In other words, the compensation is carried out after calculation of the phase difference seen during the integration of the optical signal by the pixels, during the reconstruction of the distance, typically by digital means that can be easily parameterized in this respect.

According to one embodiment, the calculation of the phase difference of time of flight comprises a trigonometric operation carried out on arguments resulting from at least two captures during which the network of pixels is controlled by a respective demodulation signal, and wherein said compensation comprises, for each pixel group, a rotation of the arguments of the trigonometric operation by an angle equivalent to the value of the phase shift introduced on the corresponding demodulation signal.

In other words, the compensation is carried out during the trigonometric calculation of the phase difference seen during the integration of the optical signal by the pixels, which allows to directly provide the phase difference of time of flight taking into account the compensation, to reconstruct the distance.

According to one embodiment, the method further comprises an emission of a light signal modulated by a modulation signal, the demodulation signal being synchronous with the modulation signal.

According to another embodiment, an integrated circuit adapted for a mapping of depths by indirect time of flight is proposed, including a network of photosensitive pixels segmented into groups of pixels, control means configured to control the pixels of the network with a demodulation signal during at least one capture of an acquisition of a depth map, the control means being configured to introduce phase shifts in the demodulation signal at different values distributed in each group of pixels.

According to one embodiment, the control means are configured to introduce phase shifts at values discretely distributed over a period of the demodulation signal.

According to one embodiment, the network is arranged into columns and into rows of pixels, and the control means are configured to introduce a number of discrete values of phase shifts between substantially one hundredth and substantially one tenth of the number of columns or of rows.

According to one embodiment, the control means are configured to introduce a number of different values of the phase shifts chosen so that the product of the frequency of the demodulation signal and said number is located outside of a bandwidth of interest.

According to one embodiment, the network is arranged into columns and into rows of pixels and the groups of pixels are segmented according to a periodic pattern on the columns and/or on the rows.

According to one embodiment, the groups of pixels are segmented according to a periodic pattern of one or more column(s) so that each group includes several spatially non-consecutive columns or several spatially non-consecutive blocks of spatially consecutive columns.

According to one embodiment, the integrated circuit further includes calculation means configured to calculate a phase difference of time of flight, for each pixel, between the demodulation signal and a light signal received during said at least one capture, and the calculation means are configured to compensate phase shift introduced by the control means on the demodulation signal for each pixel group.

According to one embodiment, the calculation means are configured to compensate for the phase shift introduced on the demodulation signal, for each pixel group, by modulo 360° adding the value of the corresponding phase shift to the phase difference of time of flight calculated.

According to one embodiment, the control means are configured to control the pixels of the network with respective demodulation signals during at least two captures of an acquisition of a depth map, the calculation means are configured to calculate the phase difference of time of flight by carrying out a trigonometric operation on arguments resulting from said at least two captures, and the calculation means are configured to compensate for the phase shift introduced on the demodulation signals, for each pixel group, by pivoting by an angle equivalent to the value of the corresponding phase shift the arguments of the trigonometric operation.

According to one embodiment, the integrated circuit further comprises an emission means configured to emit a light signal modulated by a modulation signal, and the control means are configured to generate the modulation signal and the demodulation signal synchronous with the modulation signal.

### BRIEF DESCRIPTION OF THE DRAWINGS

FIG. 1 illustrates an example of an integrated sensor of the indirect time of flight type configured to measure a depth map;

FIG. 2 shows a given block Bk from the blocks of pixels B1-B56 of the example of FIG. 1;

FIG. 3 schematically illustrates a first graph G1 showing peaks of current Ipk according to the time T in the network RES_PX during a capture, and a second graph G2 showing the amplitude EMI and the frequency F of the electromagnetic interference that results from the peaks of currents;

FIG. 4 shows groups of pixels segmented according to a periodic pattern of several columns, so that each group includes several spatially non-consecutive sets of spatially consecutive columns; and

FIG. 5 illustrates a method for compensating for the phase shifts introduced on the demodulation signal.

### DETAILED DESCRIPTION OF ILLUSTRATIVE EMBODIMENTS

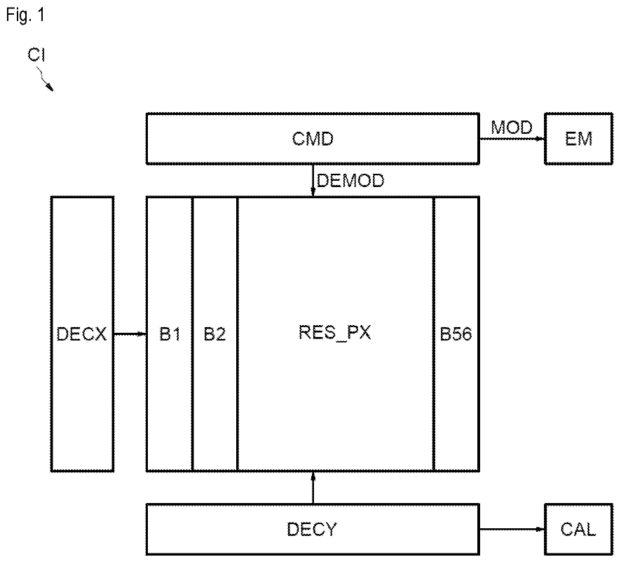

FIG. 1 illustrates an example of an integrated sensor CI of the “iToF” indirect time of flight type, intended to measure a depth map.

The integrated sensor CI includes an optical emitter EM intended to emit an optical signal modulated at a modulation frequency. The optical emitter EM comprises for example an infrared laser diode, and is modulated by a periodic modulation signal MOD, typically a step signal, at a modulation frequency for example greater than 100 MHz.

Control means CMD are configured to control phases of illumination by the optical emitter EM and in particular generate the modulation signal MOD.

The control means CMD are also configured to control a phase of integration, also called capture, of an optical signal coming from the reflection of the modulated optical signal emitted during the illumination, by a network of photosensitive pixels RES_PX.

Each capture is carried out simultaneously with the illumination, and the instants of integration of the pixels are controlled by a demodulation signal DEMOD. The demodulation signal DEMOD is synchronous with the modulation signal MOD, and allows the phase difference of the optical signal received with respect to the optical signal emitted to be measured in order to deduce therefrom the distance separating the object of the reflection and the sensor CI.

The network of photosensitive pixels RES_PX includes pixels photosensitive to the wavelength of the optical signal emitted, and can have a density of approximately iMP (MegaPixel), for example 0.5 MP. The density of the network RES_PX is also called “definition”.

The network of pixels RES_PX is arranged into columns of pixels accessible in particular via a column decoder DECY, and into rows of pixels accessible via a row decoder DECX.

The control means CMD are configured to control the pixels of the network RES_PX with a demodulation signal DEMOD during the captures, for example two or four captures, in the context of the acquisition of a depth map.

Moreover, calculation means CAL are configured to calculate the phase difference 0, also called phase difference of time of flight, between the modulation of the optical signal emitted and the modulation of the optical signal received during said at least one capture, on the basis of the quantities of charges photogenerated by the pixels of the network RES_PX controlled by the demodulation signal DEMOD.

The quantities of charges photogenerated by the pixels can typically be provided to the calculation means CAL by voltage signals coming from an analogue-digital converter incorporated into the column decoder DECY.

The column decoder DECY can also be provided for typical processing such as the subtraction of the dark currents, in addition to its function of decoding in cooperation with the line decoder DECX and according to the architecture of the network of pixels RES_PX.

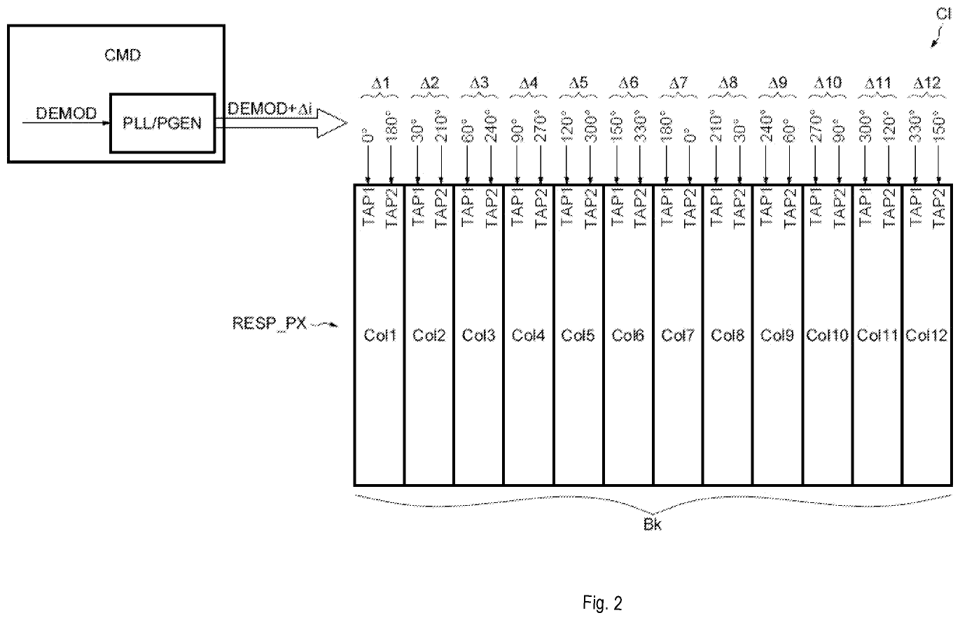

Moreover, the network of pixels RES_PX is segmented into blocks of pixels, for example fifty-six blocks B1, B2, . . . , B56, each including several columns, for example twelve columns Col1-Col12 (FIG. 2).

The segmentation into blocks of pixels could be carried out on the rows of the network RES_PX or on both rows and columns, that is to say on rectangular portions of the network of pixels RES_PX.

It is noted that the segmentation into blocks of pixels is provided in the context of a distribution of the demodulation signal and can be purely virtual, that is to say that the pixel network RES_PX does not necessarily include a structure specific to defining the blocks of the segmentation, contrary for example to the columns and the rows that correspond in particular to electrically conductive tracks contacting each pixel of the network RES_PX.

The control means CMD are indeed configured to introduce phase shifts Δ1-Δ12 (FIG. 2) into the demodulation signal DEMOD at different values distributed in respective groups of pixels.

From a hardware point of view, the control means CMD can be created by logic circuits and include a state machine, in order to implement the functions of control and of scheduling of the sensor CI, and can further include means for generating signals configured to generate in particular the modulation MOD and demodulation DEMOD signals, and introduce the phase shifts Δ1-Δ12.

In this respect reference is made to FIG. 2.

FIG. 2 shows a given block Bk out of the blocks of pixels B1-B56 of the example of

FIG. 1. In this example, the block Bk includes twelve columns Col1-Col12 of pixels.

In this example, each photosensitive pixel is of the “2-tap” type, that is to say capable of photo-generating charges, simultaneously and distinctly during two consecutive half-periods of the demodulation signal DEMOD.

The operation of the 2-tap pixels is outlined by two inputs TAP1 and TAP2 receiving the demodulation signal DEMOD offset by 180°, for example 0° on the input TAP1 and 180° on the input TAP2 in the first column Col1.

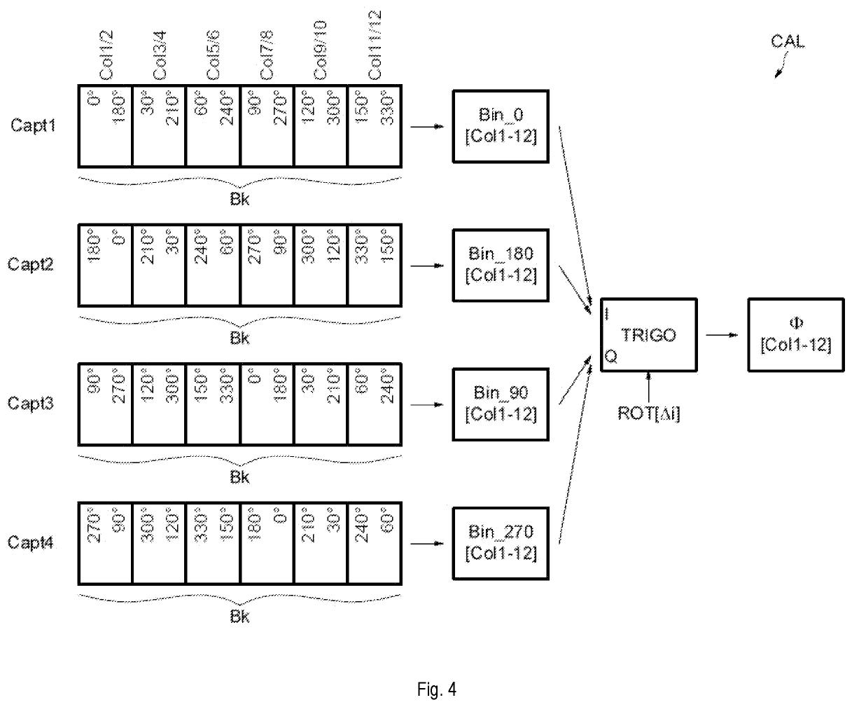

That being said, the distinction should be made (in particular in relation to FIG. 4) between the photo generation of charge of the 2-tap mechanism and a second capture Capt2 (FIG. 4) controlled by the demodulation signal DEMOD offset by 180°. Indeed, the photogeneration of charges of the 2-tap mechanism can correspond to a piece of information acquired in a “differential” manner during the control of a single demodulation signal DEMOD, while the second capture Capt2 (FIG. 4) is controlled with a “reference” demodulation signal DEMOD initially provided offset by 180° with respect to the modulation signal MOD.

The control means CMD are configured to generate the demodulation signal DEMOD, qualified as “reference”, perfectly synchronous with the modulation signal MOD controlling the emission of the optical signal. “Synchronous” means for example that the phase of the reference demodulation signal DEMOD is aligned with the phase of the modulation signal MOD (optionally offset by 180° or offset by 90° during successive captures of an acquisition, see below in relation to FIG. 4).

The control means are configured to further introduce phase shifts Δ1-Δ12 into the reference demodulation signal DEMOD, resulting in shifted demodulation signals DEMOD+Δi, with i=[1:12], for example via a phase-locked loop PLL or a phase generator PGEN.

Each column Col1, i=[1:12], of the block Bk receives a respective shifted demodulation signal DEMOD+Δi, that is to say with phase shifts Δ1-Δ12 having different values distributed in each column of pixels Col1-Col12.

In this advantageous example, the phase shifts are introduced into the reference demodulation signal DEMOD at values discretely and uniformly distributed over a period of the demodulation signal, that is to say for example twelve shifts from 0° to 330° with an interval of 30°.

This corresponds, on the input TAP2 offset by 180°, to six shifts from 180° to 330° with the interval of 30° and six shifts from 0° to 150° with the interval of 30°.

Other discrete quantities of values of phase shifts can be provided, for example sixty-four (64) shifts with an interval of 5.625°.

From a more general point of view, the quantity of discrete values of phase shifts can be provided between one hundredth of the total number of columns of the network RES_PX and one tenth of the total number of columns of the network RES_PX, for example rounded down or up to the closest integer. In the example shown in FIGS. 1 and 2, this corresponds to a quantity between 6 and 68 different discrete values.

If the groups of pixels in which the various values of the phase shifts are distributed are formed relative to the rows of the network RES_PX, then the quantity of discrete values of shifts can be defined in the same manner, relative to the total number of rows in the network RES_PX.

It is indeed advantageous to provide a “discrete” quantity of shifts, in order to limit the complexity of the generation of the phase shifts. For example, “discrete quantity” means a quantity voluntarily limited to a number much smaller than the maximum quantity of different phase shifts that can be introduced in theory, that is to say for example the total number of columns in the network of pixels RES_PX, or even more generally the total number of pixels in the network RES_PX.

Indeed, the control means CMD generating the phase shifts can thus be easily created, in a compact manner, and further be precisely calibrated on the desired values of phase shifts and according to the desired interval.

In fact, this distribution of the phase shifts, by column inside a block Bk, is applied in all the blocks B1-B56 of the network of pixels RES_PX of the sensor CI during the capture.

In other words, the pixels of each individual column Col1, i=[1:12], in all the blocks Bk, k=[1:56], are controlled during the capture with the same shifted demodulation signal DEMOD+Δi.

Thus, the phase shifts Δi are introduced into the demodulation signal DEMOD at different values distributed in respective groups of pixels, a pixel group corresponding in this example to several spatially non-consecutive columns (one column Coli, in each block Bk). In other words, the groups of pixels are segmented according to a pattern of one column, with a periodicity of one block.

That being said, the groups of pixels can be segmented according to a periodic pattern of several columns, so that each group includes several spatially non-consecutive sets of spatially consecutive columns, like in the example illustrated by FIG. 4.

Thus, during a capture, the distribution of the phase shifts on the demodulation signal in the various groups of pixels of the network results in controls of the various groups of pixels of the network that are triggered at instants distributed over time.

Alternatively, the groups of pixels can be segmented according to a pattern not having spatial periodicity, for example according to a pseudo-random, “mixed”, distribution in the network of pixels RES_PX. The distribution of the phase shifts on the demodulation signal in such a pseudo-random distribution of the various groups of pixels of the network RES_PX results in the same effects of distribution over time of the triggering of controls.

Indeed, the demodulation signal DEMOD controls switching of transistors and transfers of charges in the pixels of the network. The currents circulating in the network of pixels RES_PX resulting from these acquisition mechanisms, in particular capacitive currents, can be very high and generate electromagnetic interference.

However, the distribution over time of the instants of switching allows the electromagnetic interference to be reduced.

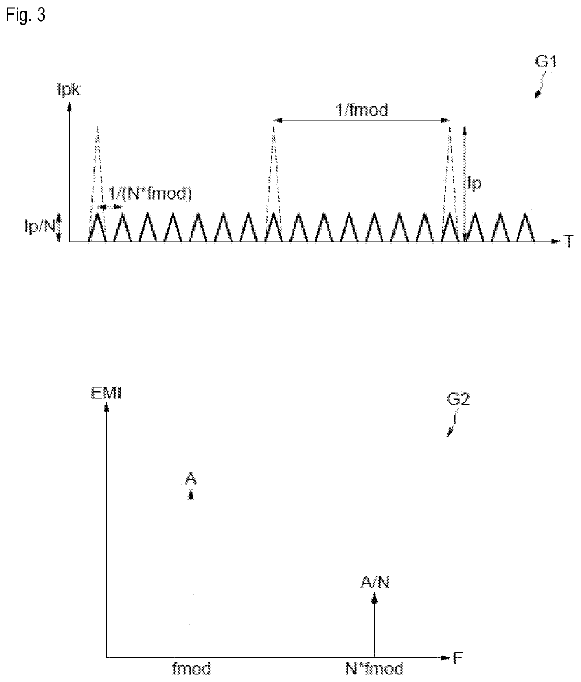

In this respect reference is made to FIG. 3.

FIG. 3 schematically illustrates in a first graph G1 the generation of peaks of current Ipk according to the time T in the network RES_PX during a capture, and in a second graph G2 the amplitude EMI and the frequency F of the electromagnetic interference that results from the peaks of currents.

In both graphs G1, G2, the curves with dashed lines illustrate the conventional case in which all the pixels of the network RES_PX are controlled at the same instant by the reference demodulation signal DEMOD.

The curves with solid lines illustrate the effect of the distribution over time of the instants of control, obtained by introducing phase shifts into the demodulation signal DEMOD at different values Δ1-Δ12 distributed in each group of pixels, as described above in relation to FIGS. 1 and 2.

In the conventional case, peaks of current having a high intensity Ip, for example up to 25 A (ampere), are generated periodically with the period i/fmod of the reference demodulation signal DEMOD, with fmod being the frequency of the reference demodulation signal, for example greater than 100 MHz.

Consequently, the electromagnetic interference is generated at the frequency fmod according to a high amplitude A.

When the pixels are controlled by the shifted demodulation signal DEMOD+Δi, with N different phase shifts distributed in N groups of pixels of the network RES_PX, there is N times less switching at the same instant, but N time more different instants of switching of groups of pixels.

Consequently, the intensity of the peaks of current Ip/N is substantially equal to the intensity of the conventional case Ip divided by N, and the period of generation of the peaks of currents is also divided by N, 1/(N*fmod) with respect to the conventional case.

Consequently, the electromagnetic interference is generated at a frequency N*fmod shifted by a factor N, and according to a lower amplitude A/N.

Thus, the embodiments and implementations described in relation to FIGS. 1 and 2 result in peaks of currents consumed in the network with intensities lower and distributed discretely over time. The amplitude of the electromagnetic interference generated by the peaks of currents is reduced proportionally to the number of different phase shifts, and the frequency of the electromagnetic interference is offset proportionally to the number of different phase shifts.

On the one hand, the number N of different values of the phase shifts Δi introduced into the demodulation signal DEMOD can be chosen in such a way that the amplitude A/N of the electromagnetic interference is sufficiently low to not disturb the operation of the sensor CI or its vicinity.

On the other hand, the number N of different values of the phase shifts Δi introduced into the demodulation signal DEMOD can also be chosen so that the frequency of the electromagnetic interference N*fmod is located outside of a bandwidth of interest.

The bandwidth of interest can for example correspond to a band of frequencies of operation of the sensor CI, so that the electromagnetic interference, having frequencies outside of this interval, does not disturb the operation of the sensor CI. Also, structural elements of the sensor CI, such as shielding of the Faraday cage type in the encapsulation cases, can absorb and attenuate electromagnetic waves located outside the bandwidth of interest. In the second case, the electromagnetic interference, the amplitude of which is already divided by N, can thus be additionally attenuated.

It is noted that the representations of the graphs G1 and G2 correspond to an introduction of the values of the phase shifts in a manner uniformly distributed over a period of the demodulation signal. This results in particular in a frequency spectrum of the electromagnetic interference positioned only on the frequency equal to the product N*fmod mentioned above.

That being said, a non-uniform distribution of the phase shifts over a period of the demodulation signal would cause a broader spectral distribution of the electromagnetic interference.

In this case, the non-uniform distribution of the phase shifts and the number N can be jointly chosen so that the frequency spectrum of the electromagnetic interference, or the majority of the spectrum, is located outside of the bandwidth of interest.

Thus, the embodiments and implementations described in relation to FIGS. 1 and 2 allow the constraints relative to the electromagnetic interference to be eliminated, which makes possible increases in the resolution of the network of pixels and in the frequency of the modulation signal, in systems for acquiring a depth map by indirect time of flight.

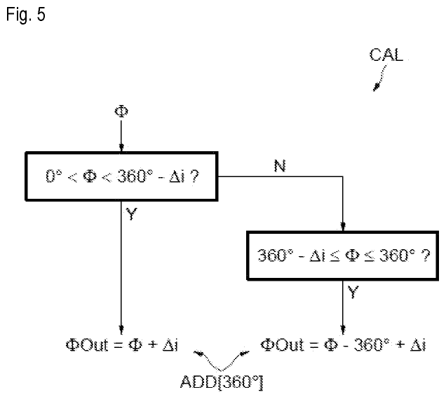

It is recalled that the measurement of distance by indirect time of flight is based on a phase difference of time of flight of the optical signal received, evaluated on the basis of the demodulation signal, and reference is made hereinafter to FIGS. 4 and 5 illustrating embodiments and implementations allowing the phase shift introduced on the demodulation signal for each pixel group in the evaluation of the phase difference of time of flight to be compensated for.

FIG. 4 illustrates on the one hand another example of segmentation of the network of photosensitive pixels into groups of pixels, and on the other hand a method for compensating for the phase shifts Δi introduced on the demodulation signal DEMOD.

In this example, the network of pixels RES_PX is firstly segmented into blocks of columns Bk as described above in relation to FIG. 1, each block Bk including twelve columns Col1-Col12.

In this example, a pixel group includes two consecutive columns Col1/2, Col3/4, . . . , Col11/12, in each block Bk.

Consequently, the groups of pixels are segmented according to a periodic pattern of two columns, so that each group includes several spatially non-consecutive sets of two spatially consecutive columns.

Moreover, FIG. 4 also illustrates a procedure for acquiring the depth map, comprising four successive captures Capt1, Capt2, Capt3, Capt4, according to a 4-bin sampling technique, the principle of which is known to a person skilled in the art.

To summarize, the technique of 4-bin sampling uses four captures, that is to say four integrations with respective illuminations, controlled with components of the demodulation signal in quadratic phase shifts.

In other words, in each capture Capt1, Capt2, Capt3, Capt4, the reference demodulation signal is respectively aligned with phases of 0°, 180°, 90°, 270° of the modulation signal MOD used for the emission of the optical signal.

The quantity of charges photogenerated by each pixel during a capture, usually called “bin”, provides a piece of information corresponding to the superposition of the phase difference of the optical signal received with respect to the phase of the demodulation signal.

For example, during the first capture Capti the pixels provide the piece of information with regard to the demodulation signal in phase Bin_0; during the second capture Capt2 the pixels provide the piece of information with regard to the demodulation signal offset by 180° Bin_180; during the third capture Capt3 the pixels provide the piece of information with regard to the demodulation signal offset by 90° Bin_90; during the fourth capture Capt4 the pixels provide the piece of information with regard to the demodulation signal offset by 270° Bin_270.

As an aside, the “2-tap” operation of the pixels allows each value of Bin to be collected twice in the two respective captures offset by 180° (for example the piece of information Bin_0 is collected by the TAP1 of the first capture Capti and by the TAP2 of the second capture Capt2). This is in particular advantageously with regard to ambient noise (usually “offset”) and matching.

The reconstruction of the phase difference Φ, also called “phase difference of time of flight”, is carried out by the calculation means CAL and comprises, for each pixel, a trigonometric operation TRIGO of the “arctan(Q/I)” type with Q an argument representative of the phase difference offset by 90° obtained by trigonometric relation on the quantities Bin_90 and Bin_270, and I an argument representative of the phase difference in phase obtained by trigonometric relation on the quantities Bin_0 and Bin_180.

The phase shift Δirespectively introduced on the demodulation signal DEMOD+Δi of each group of pixels corresponds to a rotation by a known angle in the arguments Q and I.

Consequently, to compensate for the phase shift Δi introduced on the demodulation signal DEMOD+Δi, it is possible to adapt the trigonometric calculation, for each pixel group, by pivoting the arguments Q and I by an angle equivalent to the value of the phase shift Δi respectively introduced.

The distance can then be directly calculated by knowing the compensated phase difference Φ for each group of pixels.

FIG. 5 illustrates another method for compensating for the phase shifts Δi introduced on the demodulation signal DEMOD.

In this method, the calculation means CAL are configured to obtain the value of the phase difference Φ of each pixel by a conventional trigonometric calculation, that is to say independently of the group to which the pixel belongs and without taking into account the phase shift Δi introduced on the demodulation signal DEMOD+Δi relative to this group.

The calculation means CAL are configured to compensate for each phase shift Δi introduced on the demodulation signal, on the calculated value of the phase difference Φ. Since the calculation of the phase difference Φ was carried out relative to a shifted signal DEMOD+Δi, the calculation means CAL add the value of the corresponding shift Δi to the value of phase difference Φ.

If the calculated phase difference Φ is between 0° and 360°-Δi, then the real phase difference tout is equal to Φ+Δi; and if the calculated phase difference Φ is between 360°-Δi and 360°, then the real phase difference tout is equal to Φ-360°+Δi. This amounts to carrying out a module 360° addition of the value of the phase shift Δi to the phase difference of time of flight calculated Φ.

Moreover, the invention is not limited to these embodiments and implementations and encompasses all the alternatives thereof, for example, the introduction of phase shifts into the demodulation signal at different values distributed in pixel groups can be adapted to mechanisms other than the mechanisms described, in particular the technique of 4-bin sampling of the acquisition or the 2-tap mechanism of the pixels, which were only given as advantageous examples that are in no way limiting.

What is claimed is:

1. A method for acquiring a depth map by indirect time of flight in a network of photosensitive pixels segmented into groups of pixels, wherein comprising:
performing at least one capture during which the pixels of the network are controlled by a demodulation signal; and
introducing phase shifts into the demodulation signal at different values distributed in each group of pixels.

2. The method according to claim 1, wherein the different values of the phase shifts are discretely distributed over a period of the demodulation signal.

3. The method according to claim 2, wherein the network is arranged into columns and into rows of pixels, and wherein a number of discrete values of the phase shifts is between substantially one hundredth and substantially one tenth of a number of the columns or of the rows.

4. The method according to claim 2, wherein a number of discrete values of the phase shifts is chosen so that a product of a frequency of the demodulation signal and a number (N*fmod) is located outside of a bandwidth of interest.

5. The method according to claim 1, wherein the network is arranged into columns and into rows of pixels, and wherein the groups of pixels are segmented according to a periodic pattern on the columns and/or on the rows.

6. The method according to claim 5, wherein the groups of pixels are segmented according to the periodic pattern of one or more columns so that each group includes several spatially non-consecutive columns or several spatially non-consecutive sets of spatially consecutive columns.

7. The method according to claim 1, further comprising:
calculating, for each pixel, a phase difference of time of flight between the demodulation signal and a light signal received during the at least one capture, wherein a calculation of the phase difference of time of flight comprises a compensation for a value of the phase shift introduced on the demodulation signal for each group of pixels.

8. The method according to claim 7, wherein the compensation comprises, for each pixel group, a modulo 360° addition of the value of the phase shift introduced on the corresponding demodulation signal to the phase difference of time of flight calculated.

9. The method according to claim 7, wherein the calculation of the phase difference of time of flight comprises a trigonometric operation carried out on in-phase (I) and quadrature (Q) resulting from at least two captures during which the network of pixels is controlled by a respective demodulation signal, and wherein the compensation comprises, for each group of pixels, a rotation of the in-phase (I) and the quadrature (Q) of the trigonometric operation by an angle equivalent to a value of the phase shift introduced on the corresponding demodulation signal.

10. The method according to claim 1, further comprising an emission of a light signal modulated by a modulation signal, the demodulation signal being synchronous with the modulation signal.

11. A sensor comprising:
a network of photosensitive pixels segmented into groups of pixels; and
a controller configured to:
control the pixels of the network with a demodulation signal during at least one capture of an acquisition of a depth map, and
introduce phase shifts into the demodulation signal at different values distributed in each group of pixels.

12. The sensor according to claim 11, wherein the controller is configured to introduce the phase shifts at values discretely distributed over a period of the demodulation signal.

13. The sensor according to claim 12, wherein the network is arranged into columns and into rows of pixels, and wherein the controller is configured to introduce a number of discrete values of the phase shifts between substantially one hundredth and substantially one tenth of a number of the columns or of the rows.

14. The sensor according to claim 12, wherein the controller is configured to introduce a number of different values of the phase shifts chosen so that a product of a frequency of the demodulation signal and a number (N*fmod) is located outside of a bandwidth of interest.

15. The sensor according to claim 11, wherein the network is arranged into columns and into rows of pixels, and wherein the groups of pixels are segmented according to a periodic pattern on the columns and/or on the rows.

16. The sensor according to claim 15, wherein the groups of pixels are segmented according to a periodic pattern of one or more columns so that each group includes several spatially non-consecutive columns or several spatially non-consecutive sets of spatially consecutive columns.

17. The sensor according to claim 11, further comprising a calculator configured to:
calculate a phase difference of time of flight, for each pixel, between the demodulation signal and a light signal received during the at least one capture, and
compensate for the phase shift introduced by the controller on the demodulation signal for each pixel group.

18. The sensor according to claim 17, wherein the calculator is configured to compensate for the phase shift introduced on the demodulation signal, for each pixel group, by modulo 360° adding the value of the corresponding phase shift to the phase difference of time of flight calculated.

19. The sensor according to claim 17, wherein the controller is configured to control the pixels of the network with respective demodulation signals during at least two captures of the acquisition of the depth map, wherein the calculator is configured to:
calculate the phase difference of time of flight by carrying out a trigonometric operation on in-phase (I) and quadrature (Q) resulting from the at least two captures, and compensate for the phase shift introduced on the demodulation signals, for each pixel group, by pivoting by an angle equivalent to a value of the corresponding phase shift the in-phase (I) and the quadrature (Q) of the trigonometric operation.

20. The sensor according to claim 11, further comprising an emitter configured to emit a light signal modulated by a modulation signal, wherein the controller is configured to generate the modulation signal , the demodulation signal being synchronous with the modulation signal.
